(19) United States
(12) Patent Application Publication
(10) Pub. No.: US 2015/0100615 A1
(43) Pub. Date: Apr. 9, 2015

(54) DRAG AND DROP OF A URI TO LINK RESOURCES

(71) Applicant: International Business Machines Corporation, Armonk, NY (US)

(72) Inventors: Majid Irani, San Jose, CA (US); Samuel G. Padgett, Raleigh, NC (US); Steven K. Speicher, Holly Springs, NC (US)

(73) Assignee: International Business Machines Corporation, Armonk, NY (US)

(21) Appl. No.: 14/045,095

(22) Filed: Oct. 3, 2013

(51) Int. Cl. H04L 29/08

(52) U.S. Cl. CPC H04L 67/02
USPC 709/201

(57) ABSTRACT

Arrangements disclosed herein relate linking resources based upon a user dragging a URI from a web application instance to a drop zone. A user input can be identified dragging a URI, which identifies a second resource in a web application instance, from the web application instance and dropping the URI into a drop zone associated with a first resource. Responsive to the user input dropping the URI into the drop zone, a trust between a first server providing the first resource and a second server providing the second resource can be established. Further, the first resource can be linked to the second resource on at least the first server.

### BACKGROUND

Arrangements described herein relate to data processing systems and, more particularly, to managing resources.

Application lifecycle management (ALM) is the product lifecycle management of application software. ALM encompasses requirements management, software architecture, computer programming, software testing, software maintenance, change management, project management, and release management. Several software suites, or tools, presently area available to facilitate ALM. Examples of such tools include IBM® Rational® solution for Collaborative Lifecycle Management and IBM® Rational Team Concert™.

### BRIEF SUMMARY

Arrangements disclosed herein relate linking resources based upon a user dragging a URI from one web application instance to a drop zone.

A method includes identifying a user input dragging a URI, which identifies a second resource in a first web application instance, from the first web application instance and dropping the URI into a drop zone associated with a first resource. Responsive to the user input dropping the URI into the drop zone, a trust between a first server providing the first resource and a second server providing the second resource can be established using a processor. Further, the first resource can be linked to the second resource on at least the first server.

A system includes a processor programmed to initiate executable operations. The executable operations include identifying a user input dragging a URI, which identifies a second resource in a first web application instance, from the first web application instance and dropping the URI into a drop zone associated with a first resource. Responsive to the user input dropping the URI into the drop zone, a trust between a first server providing the first resource and a second server providing the second resource can be established. Further, the first resource can be linked to the second resource on at least the first server.

A computer program product includes a computer readable storage medium having program code stored thereon. The program code is executable by a processor to perform a method. The method includes identifying, by the processor, a user input dragging a URI, which identifies a second resource in a first web application instance, from the first web application instance and dropping the URI into a drop zone associated with a first resource. Responsive to the user input dropping the URI into the drop zone, a trust between a first server providing the first resource and a second server providing the second resource can be established by the processor. Further, by the processor, the first resource can be linked to the second resource on at least the first server.

### BRIEF DESCRIPTION OF THE SEVERAL VIEWS OF THE DRAWINGS

FIG. 1 is a block diagram illustrating a system for dragging and dropping a URI to link resources in accordance with an arrangement disclosed within this specification.

FIG. 2 depicts examples of views presented in a user interface in accordance with an arrangement disclosed within this specification.

FIG. 3 depicts examples views presented in a user interface in accordance with another arrangement disclosed within this specification.

FIG. 4 is a flow chart illustrating a method of dragging and dropping a URI to link resources in accordance with an arrangement disclosed within this specification.

FIG. 5 is a block diagram illustrating a processing system for linking resources in accordance with an arrangement disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon. Any combination of one or more computer-readable medium(s) may be utilized. The computer-readable medium may be a computer-readable signal medium, a computer-readable storage medium, or a combination thereof.

As defined herein, the term “computer-readable storage medium” means a storage medium that contains or stores program code for use by or in connection with an instruction execution system, apparatus, or device. As defined herein, a “computer-readable storage medium” is not a transitory propagating signal per se. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Arrangements disclosed herein relate linking resources based upon a user dragging a URI from one web application instance to a drop zone. Specifically, a user can drag a URI identifying a second resource in a first web application instance and drop the URI to a drop zone associated with a first resource. For example, the URI can be dropped into a drop zone defined within a window or view presented by a user interface for a second web application instance, or the URI can be dropped into a drop zone defined within a project folder. In response, a trust can be established between a first server storing the first resource and a second server storing the second resource, and the second resource can be linked to the first resource. Further, information indicating the established link can be stored, for example by the first server storing the first resource. The link can be stored as a new record to a data table, as an update to an existing record in a data table, as a new file, or as an update to an existing file.

Several additional definitions that apply throughout this document will now be presented.

As defined herein, the acronym “URI” means “uniform resource identifier.” A URI can be, for example, a uniform resource locator (URL).

As defined herein, the term “drop zone” means an area in a graphical user interface configured to receive a URI in order to link a resource represented by the URI with another resource.

As defined herein, the term “trust” means an association created between at least two servers wherein each of the servers recognizes the other server(s) as trusted data sources and/or data consumers.

As defined herein, the term “resource” means data including and/or identifying at least one record, at least one file and/or at least one attribute.

As defined herein, the term “linking” means creating an association between a second resource and a first resource wherein the second resource is automatically retrievable when the first resource is accessed.

As defined herein, the term “friend folder” means a directory configured to accept at least one URI associated with a second resource in a manner that links the second resource to a first resource. In one arrangement, the URI can be accepted in a project folder defined within the friend folder, wherein the project folder is associated with the first resource. In illustration, a friend folder can include a plurality of project folders, each project folder being associated with a respective second resource.

As defined herein, to “drag” and “drop” (or “dragging” and “dropping”) means a gesture in which a user selects an object using a cursor or an appendage and moves the object from one area of a display to another area of the display or to another display. In contrast to “cut” and “paste,” to “drag” and “drop,” a user need not access a menu or select keys on a keyboard to effectuate “drag” and “drop.” “Drag” and “drop” sometimes may be referred to as “click” and “drag.”

As defined herein, the term “web application instance” means a particular user session using a web application. For example, a web application (e.g., a web browser or other web client application) can be launched a first time to initiate a first web application instance in a first window. While that window is still open in a user interface, the web application can be launched a second time to initiate a second web application instance in another window, or the user can launch another web application in another window. Both instances can be active simultaneously, and the user can move the cursor to interact with which ever web application instance the user desires.

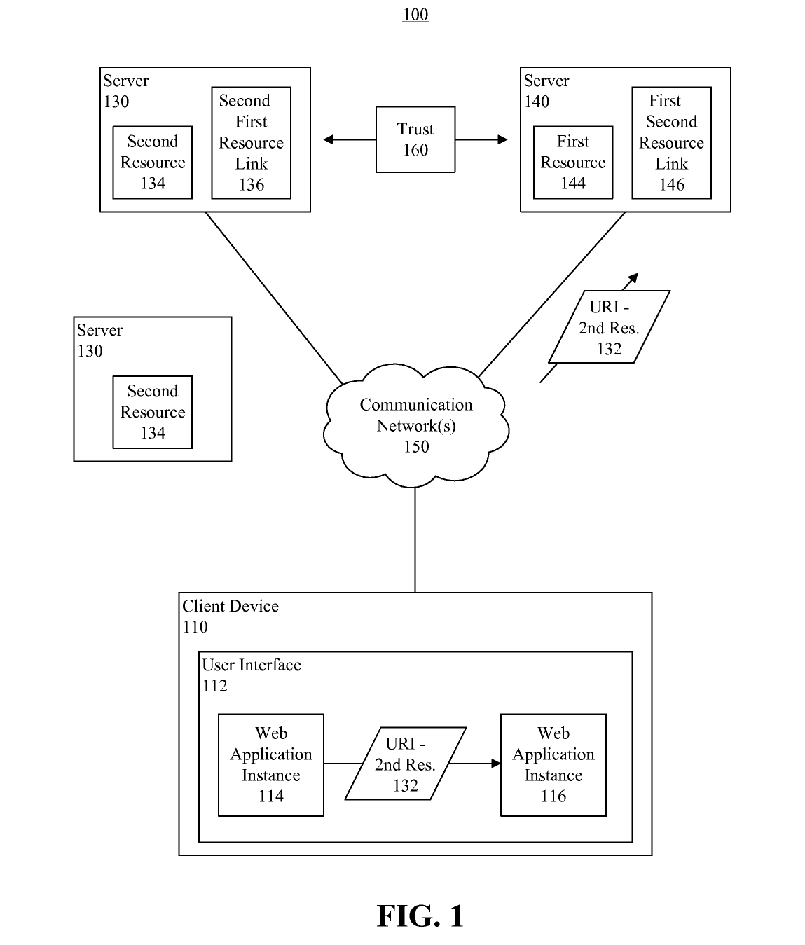

FIG. 1 is a block diagram illustrating a system 100 for dragging and dropping a URI to link resources in accordance with an arrangement disclosed within this specification. The system can include a client device 110 communicatively linked to at least a second server 130 and a first server 140 via one or more communication network(s) 150. The client device 110 can be a computer or other suitable device including at least one processor (e.g., central processing unit) and memory. Examples of a client device 110 include, but are not limited to, a workstation, a desktop computer, a mobile computer (e.g., a laptop computer, a tablet computer, a notebook computer, a netbook computer, etc.), a smart phone, a digital personal assistant, and the like. Each server 130, 140 also can include a processor and memory. In this regard, the servers 130, 140 depicted in FIG. 1 are hardware servers. Being implemented as hardware servers, 130, 140, the servers 130, 140 can execute suitable server software, applications, services and the like. The communication network(s) 150 can be implemented as, or include, any of a variety of different networks such as a WAN, a LAN, a wireless network, a mobile network, a Virtual Private Network (VPN), the Internet, the Public Switched Telephone Network (PSTN), or the like.

A user interface 112 can be presented on the client device 110, for example on one or more displays included in, or connected to, the client device 110. In the user interface 112, an instance 114 (e.g., a first instance) of a web application can be presented. Via the web application instance 114, a first user session can be established with the server 130. In the first user session, a URI 132 associated with a second resource 134 provided by the server 130 (e.g., stored by the server 130) can be presented in a window (or a tab or other suitable view) that is presented in the user interface 112 for the web application instance 114. For example, the URI 132 can be presented in an address field (or address bar) of the window.

Further, another instance 116 (e.g., a second instance) of the web application also can be presented in the user interface 112. In another arrangement, the web application instance 116 presented in the user interface 112 can be an instance of another web application. Thus, the web application instance 116 can be another instance of the same web application of which the web application instance 114 is an instance, or an instance of another web application. Information presented in a window (or a tab or other suitable view) that is presented in the user interface 112 for the web application instance 116 can correspond to a first resource 144 provided by the server 140 (e.g., stored by the server 140).

In operation, the user can drag from the web application instance 114 (e.g., from a corresponding window or view) to the web application instance 116 (e.g., to a corresponding window or view) the URI 132 associated with the second resource 134, and drop the URI 132 in the web application instance 116. In illustration, the URI 132 can be dropped into a drop zone defined in a window for the web application instance 116 that is configured to receive URIs in order to link resources as described herein. In another arrangement, the user can drag from the web application instance 114 (e.g., from a corresponding window or view) to a folder (e.g., to a corresponding window or view) the URI 132 associated with the second resource 134, and drop the URI 132 into the folder. In illustration, the URI 132 can be dropped into a drop zone defined in a window for the folder. The folder can be, for example, a friend folder or a project folder defined within a friend folder.

When the URI 132 is dropped into the drop zone, the URI 132 can be communicated, via the communication network(s) 150, from the client device 110 to the server 140. The server 140 then can make a determination as to whether a trust 160 between the server 130 and the server 140 already has been established. In another arrangement, the client device 110 can make such determination based on information exchanged between the client device 110 and the server 130 and/or server 140.

If the trust 160 is not already established, a process for establishing the trust 160 can be initiated by the server 140 or the client device 110. In illustration, responsive to identifying the URI 132 being dropped into the web application instance 116, the server 140 can, based on the URI 132, identify the server 130 and determine whether it has a trust 160 established with the server 130. If not, the server 140 can send a message to the server 130 via the communication network(s) 150 requesting that the trust 160 be established.

The server 130 can accept or deny the request. If the server 130 accepts the request, the server 130 can send a response to the server 140 indicating the request is accepted and generate data corresponding to the trust 160, which can be stored on the server 130 or on another device or system communicatively linked to the server 130. For example, the server 130 can generate a record in a data table indicating the trust 160 is established. When the server 140 receives the response, the server 140 also can generate data corresponding to the trust 160, which can be stored on the server 140 or on another device or system communicatively linked to the server 140. The trust 160 now is established based on storing of the data corresponding to the trust 160.

If the server 130 denies the request, or does not respond to the request, the client device 110, or the server 140 via the client device 110, can present in a window or view for the web application instance 116 a message indicating that the trust 160 is not established. The message further can indicate that the second resource 134 cannot be linked to the first resource 144. In response, a user can request a system administrator to establish the trust 160, and retry dragging the URI 132 to the web application instance 116 after the trust 160 is established in order to associate the second resource 134 with the first resource 144.

When it is determined that the trust 160 is established, if the user is not presently logged into the server 130 and/or the server 140, the user can be prompted to login into the server(s) 130, 140 the user is not presently logged into. In response, the user can log into the server(s) 130, 140. Further, when it is determined that the trust 160 is established, based on the URI 132 being dropped into the drop zone, the server 140, or the client device 110 via the server 140, can create a link 146 between the first resource 144 provided by the server 140 and the second resource 134 provided by the server 130. In illustration, the server 140 can create the link 146 in a data table or file. The link 146 can be created when the URI 132 is dropped, or in response to the user saving the first resource 144 or the user saving the second resource 134. Similarly, the server 130, or the client device 110 via the server 130, can create a link 136 between the second resource 134 and the first resource 144. For example, the server 140 can create the link 136 in a data table or file. Again, the link 136 can be created when the URI 132 is dropped, or in response to the user saving the first resource 144 or the user saving the second resource 134.

In one aspect, the second resource 134 can be a newly defined resource. In this case, appropriate folders, records and the like necessary for establishing the link can be created for the newly defined resource when the URI 132 is dropped. If the second resource 134 already exists, appropriate folders, records and the like associated with the second resource 134 can be used to establish the link(s) 136, 146 if such folders, records and the like already exist.

In one arrangement, the link(s) 136, 146 can be change request links established between the second resource 134 and the first resource 144. Being implemented as change request links, the link(s) 136, 146 can indicate that the second resource 134 is a resource being newly associated with the first resource 144 and vice versa.

The link 146 can include various attributes related to the second resource 134. Similarly, the link 136 can include various attributes related to the first resource 144. For example, a “type” attribute can be included in each of the links 136, 146. The type attribute included in the link 146 can indicate the nature of the second resource 134, and the type attribute included in the link 136 can indicate the nature of the first resource 144. In illustration, if the first resource 144 is related to a particular module of an application under development, the type attribute included in the link 146 can indicate whether the second resource 134 indicates a defect, a plan item, a task or a requirement. This is just one example of an attribute that can be associated with the links 136, 146 and the present arrangements are not limited in this regard.

In one arrangement, the attributes for the links 136, 146 can be attributes associated with respective project folders. In illustration, the server 140 can include a friend folder (e.g., a root folder) that includes one or more project folders, at least one of which is associated with the first resource 144. The attributes for the link 146 associated with this folder can include the type attribute previously described, as well as one or more action type attributes, such as “link to existing resource” or “link to new resource,” “create new link” or “update existing link,” and the like.

In one aspect, when the user drags and drops the URI 132 into the web application instance 116 (or folder), the URI 132 may correlate with a plurality of resources, including the second resource 134. In this case, the user interface 112 can present to the user, for example via the web application instance 114, a list of resources correlating with the URI 132. From the list, the user can select the second resource 134. Moreover, the user can select other resources in addition to the second resource 134. The link 146 that is established can be a link not only to the second resource 134, but also a link to any other resources selected by the user. In this regard, batch linking can be implemented. Moreover, the resources associated with the URI can be presented to the user sequentially to prompt the user to accept or deny association of each resource with the first resource 144. Further, for each of the other resources selected in addition to the second resource, additional links between the first resource 144 and such other resources also can be created by the server 130 and/or the client device 110.

Similarly, when the user drags and drops the URI 132 into the web application instance 116 (or folder), and a plurality of items are presented by the web application instance 116 (or folder), a window or other view (e.g., a pop-up window) can be presented to the user to select the first resource 144 from the plurality of resources, for example from a menu. When the user selects the first resource 144, establishing the trust 160 and linking of the second resource 134 to the first resource 144 can commence as described herein.

In one arrangement, the user can drag and drop not only the URI 132 correlating to the second resource 134 to the drop zone, but also can drag and drop other URIs correlating to other respective resources. In this case, the user can be prompted to select a resource provided by the server 140 for each of the URIs dropped in the drop zone, and each correlating resource can be associated with a respective resource provided by the server 140 that is selected by the user. In illustration, for the URI, the user can select the first resource 144. For another URI, the user can select either the first resource 144 or another resource provided by the server 140, and so on. The resources provided by the server 140 can be existing resources or new resources. In this regard, for each URI that is dropped in the drop zone, the user can be prompted to choose an existing resource provided by the server 140 to which to link to the resource corresponding to the URI, or to initialize creation of a new resource on the server 140 to which to link the resource corresponding to the URI. The user also can choose to cancel such linking at any time during the process.

In another example, a query identifying a plurality of resources, including the resource 134, can be presented in the web application instance 114 and represented by the URI 132. When the URI 132 is dragged and dropped to the web application instance 116 (or folder), in one arrangement, the result-set of the query (i.e., each of the items identified by the query) can be linked to the first resource 144. In another arrangement, the user can be presented a window or other view including the result-set of the query from which the user may select one or more items that are to be linked to the first resource 144. In response to the user selecting one or more of the items, such items can be linked to first resource 144. In such case, each item can be considered an individual resource. In another arrangement, for each item selected, the user can be prompted to choose an existing resource provided by the server 140 to which to link the selected item, or to initialize creation of a new resource on the server 140 to which to link the selected item. Again, in this example, each item can be considered an individual resource. The user also can choose to cancel such linking at any time during the process.

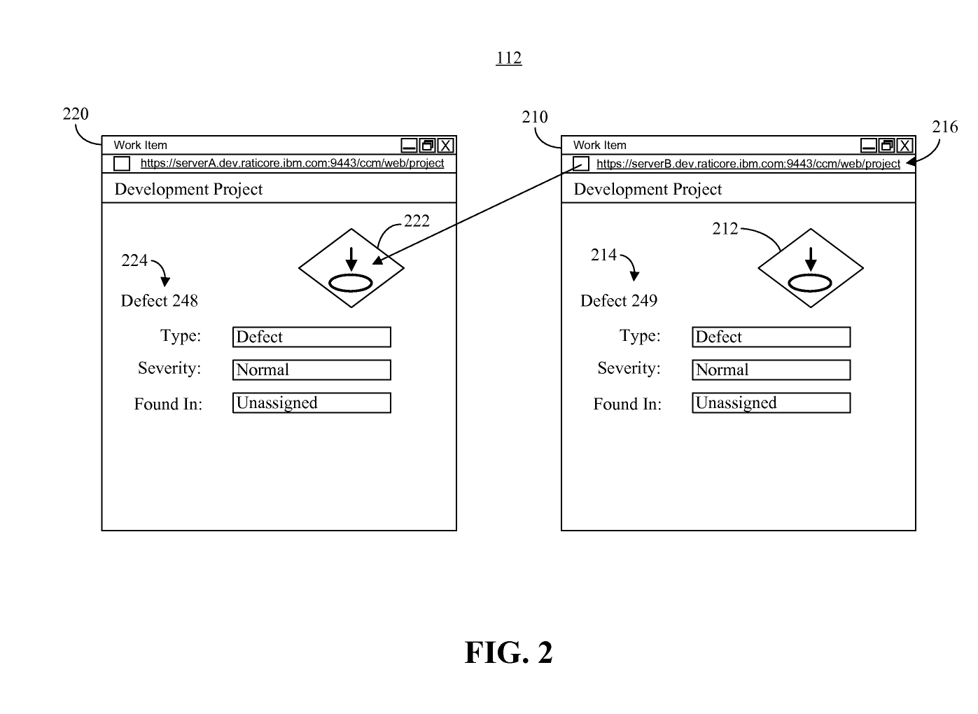

FIG. 2 depicts examples of views (e.g., windows) 210, 220, presented in the user interface 112 in accordance with an arrangement disclosed within this specification. Each view 210, 220 can be presented for a respective web application instance (e.g., the web application instance 114 and the web application instance 116 depicted in FIG. 1). One or more of the views 210, 220 can include respective drop zones 212, 222 configured to receive a URI in order to link a resource represented by the URI with one or more resources 214, 224 represented in, or by, the respective views 210, 220. For example, the drop zone 222 presented in the view 220 can be configured to receive a URI in order to link a resource represented by the URI with a “Defect 248” resource 224.

In operation, if a user chooses to associate the resource 214 presented in the view 210 with the resource 224 presented in the view 220, the user can drag a URI 216 associated with the resource 214 to the drop zone 222. In response, establishing a trust between a second server providing the second resource 214 and a first server providing the first resource 224 can be initiated as described herein. Further, when it is determined that the trust has been established, the second resource 214 can be linked to the first resource 224 as described herein.

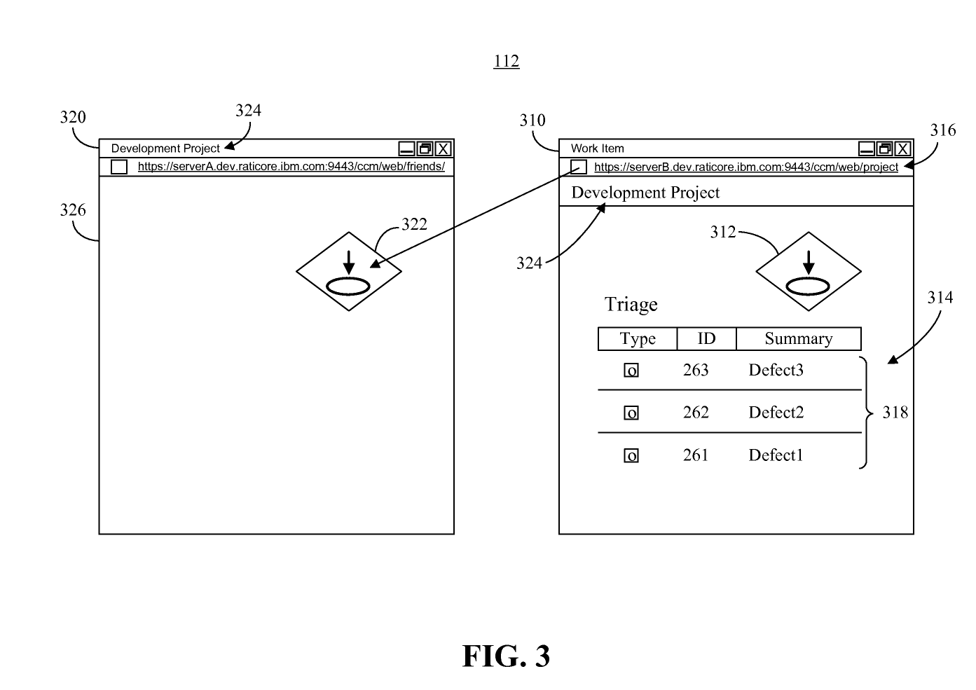

FIG. 3 depicts examples of views (e.g., windows) 310, 320 presented in the user interface 112 in accordance with another arrangement disclosed within this specification. The view 310 can be presented for a particular web application instance (e.g., the web application instance 114), and the view 310 can be presented for a friend folder, for example a particular project folder within the friend folder. The friend and/or project folder(s) can be expanded or collapsed by the user via suitable user inputs. One or more of the views 310, 320 can include respective drop zones 312, 322 configured to receive a URI in order to link a resource represented by the URI with one or more resources represented in, or by, the respective views 210, 220. In illustration, the view 320 can include the drop zone 322. In one arrangement, the drop zone 322 can be indicated by a graphic item, such as an icon, picture or the like. In another arrangement, no such graphic item need be indicated, and a body 326 of the view 320 can represent the drop zone 322. In one aspect, the project folder can represent a resource 324 which also is presented in the view 310 presented in the view 310. In illustration, the user can select the resource 324 presented in the view 310 to open the view 320 to the project folder that is associated with the resource 324.

In operation, if a user chooses to associate the resource 314 presented in the view 310 with the resource 324 associated with the view 320, the user can drag a URI 316 associated with the resource 314 to the drop zone 322. As noted, if the resource 314 includes a plurality of items 318, the user can be prompted to choose which items 318 of the resource 314 are to be associated with the resource 324, for example as previously described. Further, if the URI 316 is dragged and dropped into a friend folder, the user can be prompted to select a project folder for which resources are to be linked or to create a new project folder, in which case a new project folder can be created in the friend folder. In response to the URI 316 being dragged and dropped into the drop zone 322, establishing a trust between a second server providing the second resource 314 and a first server providing the first resource 324 can be initiated as described herein. Further, when it is determined that the trust has been established, the second resource 314 can be linked to the first resource 324 as described herein.

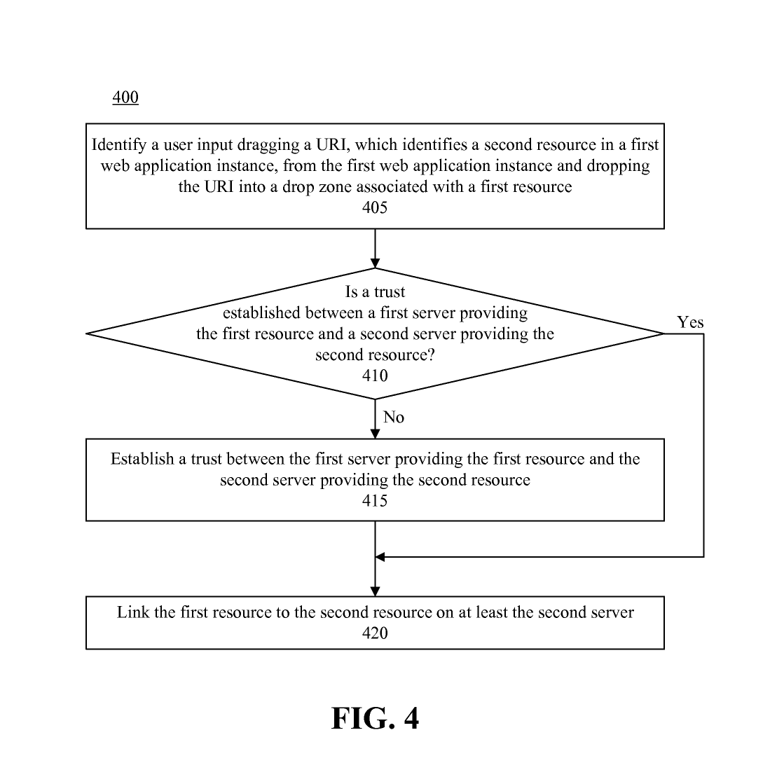

FIG. 4 is a flow chart illustrating a method 400 of dragging and dropping a URI to link resources in accordance with an arrangement disclosed within this specification. In one arrangement, the method 400 can be implemented by the server 140 of FIG. 1. In another arrangement, the method 400 can be implemented by the client device 110 of FIG. 1.

At step 405, a user input can be identified dragging a URI, which identifies a second resource in a first web application instance, from the first web application instance and dropping the URI into a drop zone associated with a first resource. For example, the user interface 112 (FIG. 1) can detect the URI being dragged and dropped, and communicate an indication of the drag and drop to the server 140 (FIG. 1). Such indication can include the URI 132 (FIG. 1), and can be identified by the server 140.

At decision box 410, responsive to the user input dropping the URI into the drop zone, a determination can be made as to whether a trust is established between a second server providing the second resource and a first server providing the first resource. If the trust is not established, at step 415 the trust between the second server providing the second resource and the first server providing the first resource can be established. At step 420, the second resource can be linked to the first resource on at least the first server, for example as described herein.

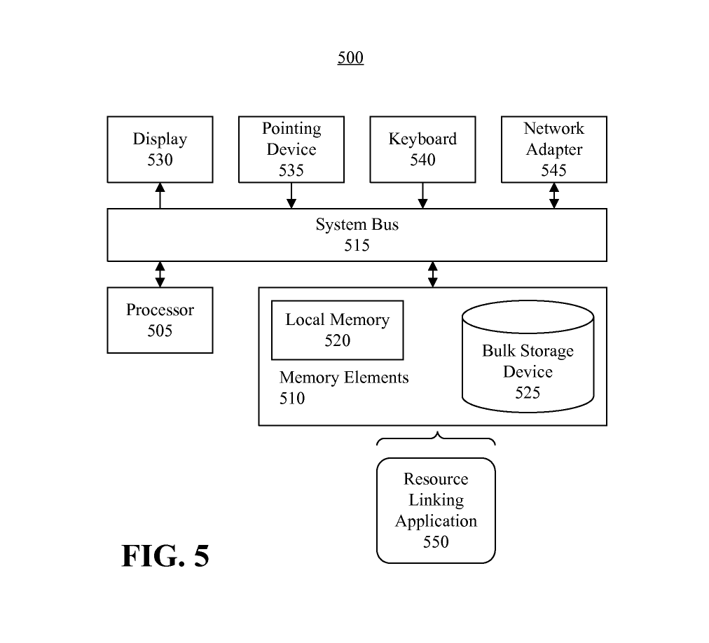

FIG. 5 is a block diagram illustrating a processing system 500 for linking resources in accordance with an arrangement disclosed within this specification. The processing system 500 is illustrative of components that can be included in the client device 110, the server 130 and/or the server 140 of FIG. 1.

The processing system 500 can include at least one processor 505 (e.g., a central processing unit) coupled to memory elements 510 through a system bus 515 or other suitable circuitry. As such, the processing system 500 can store program code within the memory elements 510. The processor 505 can execute the program code accessed from the memory elements 510 via the system bus 515. It should be appreciated that the processing system 500 can be implemented in the form of any system including a processor and memory that is capable of performing the functions and/or operations described within this specification. For example, the processing system 500 can be implemented as a computer, a workstation, a mobile computer, a laptop computer, a tablet computer, a smart phone, a personal digital assistant, a gaming device, an appliance, and so on.

The memory elements 510 can include one or more physical memory devices such as, for example, local memory 520 and one or more bulk storage devices 525. Local memory 520 refers to RAM or other non-persistent memory device(s) generally used during actual execution of the program code. The bulk storage device(s) 525 can be implemented as a hard disk drive (HDD), solid state drive (SSD), or other persistent data storage device. The processing system 500 also can include one or more cache memories (not shown) that provide temporary storage of at least some program code in order to reduce the number of times program code must be retrieved from the bulk storage device 525 during execution.

Input/output (I/O) devices such as a display 530, a pointing device 535 and a keyboard 540 optionally can be coupled to the processing system 500. For example, the client device 110 (FIG. 1) can include the display 530, the pointing device 535 and the keyboard 540, whereas the servers 130, 140 (FIG. 1) need not include such devices. The I/O devices can be coupled to the processing system 500 either directly or through intervening I/O controllers. For example, the display 530 can be coupled to the processing system 500 via a graphics processing unit (GPU), which may be a component of the processor 505 or a discrete device. One or more network adapters 545 also can be coupled to processing system 500 to enable processing system 500 to become coupled to other systems, computer systems, remote printers, and/or remote storage devices through intervening private or public networks. Modems, cable modems, transceivers, and Ethernet cards are examples of different types of network adapters 545 that can be used with processing system 500.

As pictured in FIG. 5, the memory elements 510 can store a resource linking application 550 configured to link resources as described herein in response to a user dragging a URI from a first web application instance and dropping the URI in a second web application instance. Being implemented in the form of executable program code, the resource linking application 550 can be executed by the processing system 500 and, as such, can be considered part of the processing system 500. Moreover, the resource linking application 550 is a functional data structure that imparts functionality when employed as part of the processing system 500 of FIG. 5.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method comprising:
identifying a user input dragging a URI, which identifies a second resource in a first web application instance, from the first web application instance and dropping the URI into a drop zone associated with a first resource; and
responsive to the user input dropping the URI into the drop zone:
establishing, using a processor, a trust between a first server providing the first resource and a second server providing the second resource; and
linking the first resource to the second resource on at least the first server.

2. The method of claim 1, further comprising:
determining whether the trust between the first server providing the first resource and the second server providing the second resource has already been established;
wherein establishing the trust between the first server storing the first resource and the second server storing the second resource further is responsive to determining that the trust between the first server storing the first resource and the second server storing the second resource has not already been established.

3. The method of claim 1, further comprising:
responsive to establishing the trust between the first server storing the first resource and the second server storing the second resource, prompting a user to log into the first server storing the first resource or the second server storing the second resource.

4. The method of claim 1, further comprising:
responsive to the user input dropping the URI into the drop zone, determining whether the second resource is a newly defined resource; and
responsive to determining that the second resource is a newly defined resource, submitting the second resource to the second server to be stored.

5. The method of claim 1, further comprising:
presenting to a user a plurality of items, the plurality of items including the second resource; and
identifying a user selection of at least two of the plurality of items;
wherein linking the second resource to the first resource on at least the first server comprises linking the items selected by the user to the first resource.

6. The method of claim 1, wherein linking the second resource to the first resource on at least the first server comprises establishing a change request link between the second resource and the first resource.

7. The method of claim 1, wherein the drop zone is defined in a second web application instance.

8. The method of claim 1, wherein the drop zone is defined in a project folder associated with the first resource.

9. A system comprising:
a processor programmed to initiate executable operations comprising:
identifying a user input dragging a URI, which identifies a second resource in a first web application instance, from the first web application instance and dropping the URI into a drop zone associated with a first resource; and
responsive to the user input dropping the URI into the drop zone:
establishing a trust between a first server providing the first resource and a second server providing the second resource; and
linking the first resource to the second resource on at least the first server.

10. The system of claim 9, the executable operations further comprising:
determining whether the trust between the first server providing the first resource and the second server providing the second resource has already been established;
wherein establishing the trust between the first server storing the first resource and the second server storing the second resource further is responsive to determining that the trust between the first server storing the first resource and the second server storing the second resource has not already been established.

11. The system of claim 9, the executable operations further comprising:
responsive to establishing the trust between the first server storing the first resource and the second server storing the second resource, prompting a user to log into the first server storing the first resource or the second server storing the second resource.

12. The system of claim 9, the executable operations further comprising:
responsive to the user input dropping the URI into the drop zone, determining whether the second resource is a newly defined resource; and
responsive to determining that the second resource is a newly defined resource, submitting the second resource to the second server to be stored.

13. The system of claim 9, the executable operations further comprising:
presenting to a user a plurality of items, the plurality of items including the second resource; and
identifying a user selection of at least two of the plurality of items;
wherein linking the second resource to the first resource on at least the first server comprises linking the items selected by the user to the first resource.

14. The system of claim 9, wherein linking the second resource to the first resource on at least the first server comprises establishing a change request link between the second resource and the first resource.

15. The system of claim 9, wherein the drop zone is defined in a second web application instance.

16. The system of claim 9, wherein the drop zone is defined in a project folder associated with the first resource.

17. A computer program product comprising a computer readable storage medium having program code stored thereon, the program code executable by a processor to perform a method comprising:
identifying, by the processor, a user input dragging a URI, which identifies a second resource in a first web application instance, from the first web application instance and dropping the URI into a drop zone associated with a first resource; and
responsive to the user input dropping the URI into the drop zone:
establishing, by the processor, a trust between a first server providing the first resource and a second server providing the second resource; and
linking, by the processor, the first resource to the second resource on at least the first server.

18. The computer program product of claim 17, the method further comprising:
determining whether the trust between the first server providing the first resource and the second server providing the second resource has already been established;
wherein establishing the trust between the first server storing the first resource and the second server storing the second resource further is responsive to determining that the trust between the first server storing the first resource and the second server storing the second resource has not already been established.

19. The computer program product of claim 17, wherein the drop zone is defined in a second web application instance.

20. The computer program product of claim 17, wherein the drop zone is defined in a project folder associated with the first resource.
